(19) United States
(12) Patent Application Publication
(10) Pub. No.: US 2018/0296876 A1
(43) Pub. Date: Oct. 18, 2018

(54) BREATHING MASK

(71) Applicant: K670 GmbH, Salzburg (AT)

(72) Inventors: Dominique WENGER, Salzburg (AT); Nicolas WENGER, Salzburg (AT); Erwin WEITGASSER, Salzburg (AT); Detlev MAGERER, Salzburg (AT)

(21) Appl. No.: 15/770,817

(22) PCT Filed: Jun. 2, 2017
(86) PCT No.: PCT/AT2017/050012

§ 371 Date: Apr. 25, 2018

(30) Foreign Application Priority Data
Jun. 15, 2016 (AT) A 50544/2016

(51) Int. Cl. A63B 23/18; A62B 18/10; A63B 21/00

(52) U.S. Cl. CPC A63B 23/18; A63B 21/00069; A62B 18/10

(57) ABSTRACT

A breathing mask has a mask body covering the mouth and nose, which may form an air inlet and an air outlet provided with a check valve. The air inlet may have a rotary slide valve in a seat which has at least one air inlet opening surrounding the central air outlet in sections. The rotary slide valve may cover the air inlet opening differently depending on its rotational position. The check valve for the air outlet may have a centrally-held membrane which covers an air outlet opening. The air outlet may form a guide cylinder for the rotary slide valve. The rotary slide valve may form the air outlet opening covered by the membrane.

### FIELD OF THE INVENTION

The invention relates to a breathing mask having a mask body covering the mouth and nose, which forms an air inlet and an air outlet provided with a check valve,

### DESCRIPTION OF THE PRIOR ART

In order to train the breathing and the respiratory muscles, the inhalation resistance can be increased. For this purpose, breathing masks are used which have an air inlet with a correspondingly reduced flow cross-section and an air outlet which is separate from the air inlet and is equipped with a check valve and which is provided for unobstructed exhalation with a comparatively large flow cross-section. In order to ensure that the inhalation resistance can be adapted to different requirements, it is known (US 2012/0094806 A1) to close the air inlet with interchangeable screw caps having a different number of air inlet openings or differently large air inlet openings, so that with the selection of corresponding screw caps the flow cross-section of the air inlet can be adapted to different requirements. The disadvantage, however, is the relatively complex construction caused by the spatially separated arrangement of the air inlet and outlet, and the need to use different screw caps for a required adjustment of the air inlet.

Moreover, it is known from a device for the treatment of sleep-induced respiratory disorders (US 2015/0040907 A1) to provide a cylindrical housing which at a front end forms an air inlet provided with a check valve and in the shell has an air outlet opening extending over a circumferential area, which opening is covered to different degrees by means of a slide encompassing a cylinder jacket on the outside, so that only the exhalation resistance can be adjusted by the slide. The check valve, which is formed by a centrally held membrane covering the air inlet opening, is provided to ensure unimpeded inhalation.

### SUMMARY OF THE INVENTION

The invention is therefore based on the object of forming a breathing mask in such a way that with simple constructive means the inhalation resistance can be adapted to different requirements,

Starting from a breathing mask of the type described above, the invention

achieves the stated object in that the air inlet comprises a rotary slide valve in a seat which has at least one air inlet opening surrounding the central air outlet in sections, the rotary slide valve covers the air inlet opening differently depending on its rotational position, the check valve for the air outlet has a centrally-held membrane which covers an air outlet opening, the air outlet forms a guide cylinder for the rotary slide valve, and the rotary slide valve forms the air outlet opening covered by the membrane.

By providing a central air outlet in the seat for the rotary slide valve, which cooperates with at least one air inlet opening enclosing the air outlet in sections, the conditions for a simple, compact design are created, wherein an advantageous adjustment of the flow cross-section for the air inlet is provided through the rotary slide valve cooperating with the at least one air inlet opening. The respective rotational position of the rotary slide valve determines the angle over which the air inlet opening is covered by the rotary slide valve, and thus the inhalation resistance, The central air outlet also allows the formation of the check valve required for the air outlet as a structurally low-complex membrane valve with a centrally held membrane covering an air outlet opening, so that the membrane is lifted during exhalation from the edge of the air outlet opening and releases the air outlet opening. The negative pressure which occurs during inhalation supports the tight contact of the membrane at the peripheral edge of the air outlet opening.

Since the air outlet forms a guide cylinder for the rotary slide valve and the rotary slide valve forms the air outlet opening covered by the membrane, it requires no separate support of the membrane by receiving the rotary slide valve, because the rotary slide valve, which forms the air outlet opening to be covered by the membrane, can assume the central support of the membrane itself. The support of the membrane which is at the center with respect to the air outlet opening can indeed be formed simply by a hub carried by spokes within the air outlet opening, wherein said spokes can be advantageously used for radial support of the membrane in the closed position of the check valve.

In order to secure the axial position of the rotary slide valve rotatably mounted in the guide cylinder, the rotary slide valve can engage behind the guide cylinder with axial spring tongues which form a kind of snap closure, so that the rotary slide valve, which for its guidance forms corresponding axial guide lugs in the guide cylinder, only needs to be inserted into the guide cylinder with the spring tongues at the front until the spring tongues engage behind the inner front edge of the guide cylinder.

In order to specify different flow cross-sections for the air inlet, the rotary slide valve may have a radially outwardly projecting, resilient latch which cooperates with circumferentially successive latching recesses of the seat. Thus, the rotary slide valve is locked in different rotational positions which, due to the different coverage of the air inlet opening, respectively correspond to a different flow cross-section and thus to a different inhalation resistance.

In order to specify different flow cross-sections for the air inlet, the rotary slide valve may have a radially outwardly projecting, resilient latch which cooperates with circumferentially successive latching recesses of the seat. Thus, the rotary slide valve is latched into different rotational positions which, due to the different cover of the air inlet opening, respectively correspond to a different flow cross-section and thus to a different inhalation resistance.

If the air inlet is divided into several air inlet openings distributed around the air outlet, then the setting angle for the rotary slide valve for the adjustment of different flow cross-sections is reduced. Advantageous constructive conditions arise in this context, when the seat and the rotary slide valve each have three air inlet openings which are evenly distributed around the air outlet and each extend at an angular range of 60°, because in this case the rotary slide valve only needs to be adjusted by 60° between the closed position and the full open position.

### BRIEF DESCRIPTION OF THE INVENTION

The subject matter of the invention is shown by way of example in the drawings, wherein:

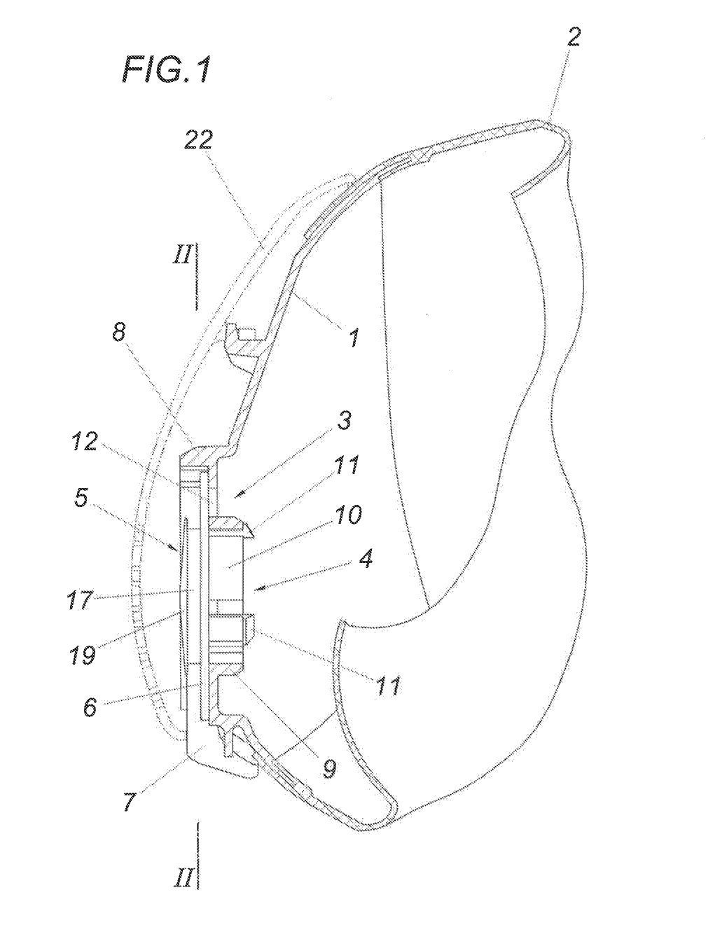

FIG. 1 shows a breathing mask according to the invention in the region of the air inlet and outlet in a simplified longitudinal section,

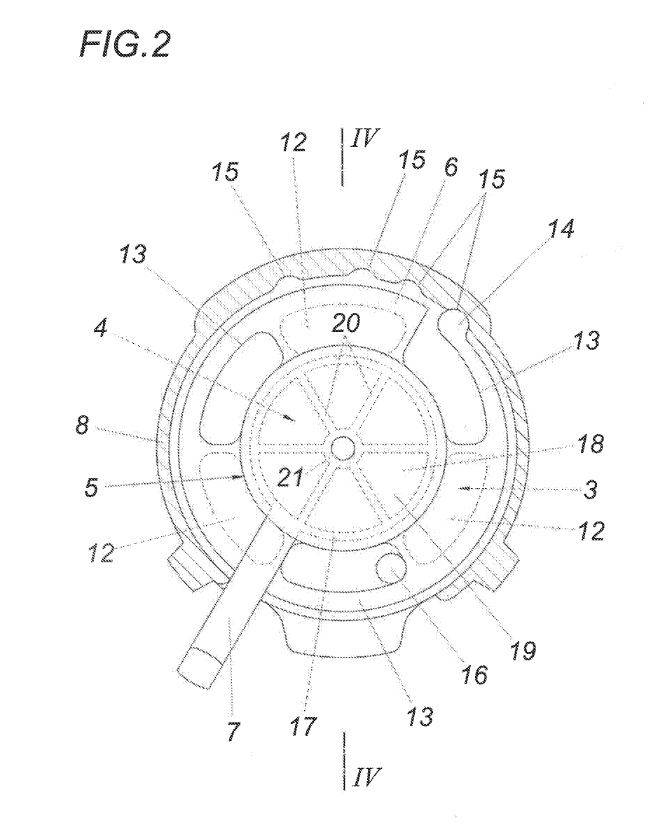

FIG. 2 shows a section along the line II-II of FIG. 1 on a larger scale,

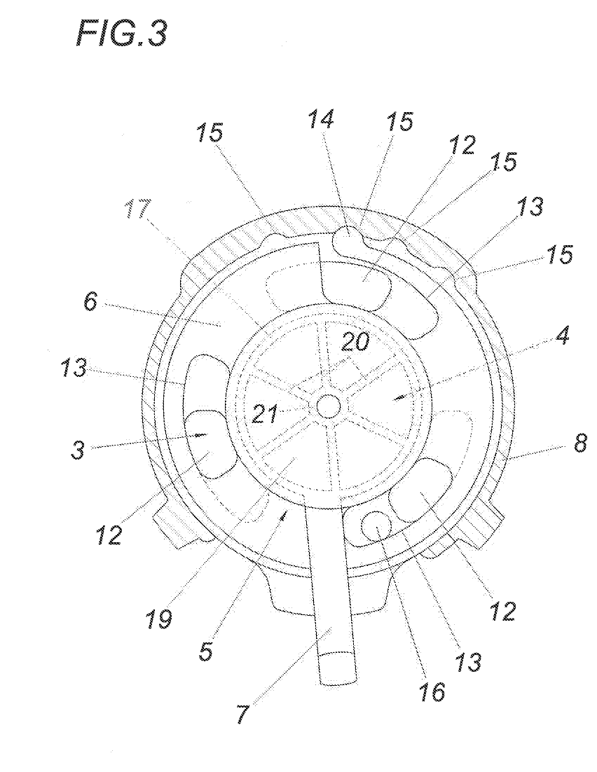

FIG. 3 shows a representation corresponding to FIG. 2, but in a different rotational position of the rotary slide valve in relation to FIG. 1, and

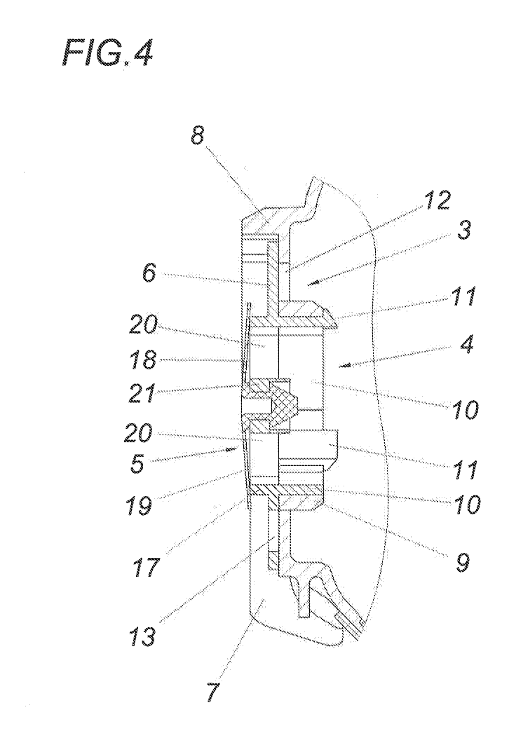

FIG. 4 shows a section along the line IV-IV of FIG. 2 on a larger scale.

### DESCRIPTION OF THE PREFERRED EMBODIMENT

The breathing mask according to the illustrated embodiment has a mask body 1, covering the mouth and nose, and is provided for tight connection to the face shape with a flexible sealing edge 2. The mask body 1 is provided with an air inlet 3 and an air outlet 4, which cooperates with a check valve 5. The air inlet 3 is associated with a rotary slide valve 6 to adjust the flow cross-section, which can be adjusted via a hand lever 7. The mask body 1 forms a seat 8 for the rotary slide valve 6, which comprises the central air outlet 4, which is limited by a guide cylinder 9 for the rotary slide valve 6. For the support of the rotary slide valve 6 in the guide cylinder 9, the rotary slide valve 6 is provided with radial guide lugs 10, which keep the rotary slide valve 6 centered with respect to the guide cylinder 9. The axial securing of the rotary slide valve 6 is achieved by spring tongues 11, which engage behind the guide cylinder 9 on the inner end face, as shown in particular in FIG. 4.

The seat 8 for the rotary slide valve 6 has three air inlet openings 12 uniformly enclosing the air outlet 4, which cooperate with corresponding air passage openings 13 of the rotary slide valve 6. Since the air inlet openings 12 of the air inlet 3 and the air passage openings 13 extend in the rotary slide valve 6 in each case over an angular range of 60°, the flow cross-section released by the rotary slide valve 6 between the closed position covering the air inlet openings 12 and an open position completely releasing the air inlet openings 12 can be adjusted by a rotary adjustment of the rotary slide valve 6 by 60°. In order to determine certain rotational positions of the rotary slide valve 6, it may be provided with a radially outwardly projecting, resilient latch 14, which cooperates with circumferentially successive latching recesses 15 of the seat 8. FIG. 2 shows the closing position and FIG. 3 shows the partially open position. In order to not completely interrupt the air supply in the closing position, an additional air inlet opening 16 which remains open at all times can be provided.

In order to achieve simple constructive conditions, the rotary slide valve can form with a cylindrical projection 17 a central air outlet opening 16 for the air outlet 4 and accommodate the check valve 5. The check valve 5 is formed by a membrane 19 which is held by a hub 21 supported by spokes 20 and cooperates with the front edge of the cylindrical projection 17, wherein the spokes 20 represent an additional support of the membrane 19 in the closed position. During Inhalation, a negative pressure arises on the inside of the air outlet 4, which holds the membrane 19 in the closed position, so that air can be sucked in and inhaled only over the sections of the air inlet openings 12 released by the rotary slide valve 6. During exhalation, the excess pressure of the exhaled air produces an opening of the check valve 5 in that the membrane 18 is lifted from the front edge of the cylindrical projection 17, so that in addition to the released sections of the air inlet openings 12 the air outlet opening 18 is also available for the unobstructed exhalation.

To protect the check valve 5, the seat 8 of the mask body 1 is provided with an air-permeable cover 22, which is indicated in FIG. 1 with a dot-dash line.

1. A breathing mask, comprising:
a mask body configured to cover at least one of a mouth and a nose, the mask body including
an air inlet having a rotary slide valve in a seat, the rotary slide valve having a plurality of air inlet openings, wherein the rotary slide valve is configured to assume a plurality of rotational positions that permit the passage of different
a central air outlet having an air outlet opening and a check valve configured to cover the air outlet opening, wherein the central air outlet forms a guide cylinder configured to receive the rotary slide valve and the plurality of air inlet openings of the rotary slide valve surround the central air outlet and wherein the air outlet opening is formed in the rotary slide valve.

2. The breathing mask of claim 1, wherein the rotary slide valve is configured to engage the guide cylinder with one or more axial spring tongues.

3. The breathing mask of claim 1, wherein the rotary slide valve includes an outwardly-projecting resilient latch configured to be removably seated within circumferentially successive latching recesses in the seat of the rotary slide valve.

4. The breathing mask of claim 1, wherein the seat and the rotary slide valve each comprise three air inlet openings evenly distributed around the central air outlet each air inlet opening extending about an angular range of 60°.

5. The breathing mask of claim 4, wherein the check valve is configured to allow unimpeded airflow through the air inlet openings of the seat when the air inlet openings of the seat and the air inlet openings of the check valve are rotationally aligned.

6. The breathing mask of claim 4, wherein the check valve is configured to at least partially block airflow through the air inlet openings of the seat when the air inlet openings of the seat and the air inlet openings of the check valve are not rotationally aligned.

7. The breathing mask of claim 3, wherein at least one latching recess in the seat is configured to hold the rotary slide valve in a rotational position in which airflow through the air inlet is blocked.

8. The breathing mask of claim 3, wherein at least one latching recess in the seat is configured to hold the rotary slide valve in a rotational position in which air may pass through the air inlet.

9. The breathing mask of claim 1, wherein the check valve includes a membrane covering the air outlet opening, wherein the membrane is configured to substantially prevent airflow through the air outlet opening during inhalation and to allow airflow through the air outlet opening during exhalation.

10. The breathing mask of claim 1, wherein the check valve is seated within the rotary slide valve.

11. A breathing mask, comprising;
a valve seat including at least one air inlet opening and a seat opening in a central portion of the valve seat; and
a rotary slide valve at least partially seated within the seat opening, wherein the rotary slide valve includes at least one air inlet opening and is configured to rotate relative to the valve seat into:
a first rotational position in which the air inlet openings of the valve seat are rotationally aligned with the inlet openings of the rotary slide valve such that airflow through the air inlet openings is unimpeded, and
a second rotational position in which the air inlet openings of the valve seat are not rotationally aligned with the inlet openings of the rotary slide valve such that airflow through the air inlet openings of the valve seat is at least partially blocked.

12. The breathing mask of claim 11, wherein the valve seat includes a first latching recess configured to hold the rotary slide valve in the first rotational position and a second latching recess configured to hold the rotary slide valve in the second rotational position.

13. The breathing mask of claim 12, wherein the first latching recess and second latching recess are circumferentially spaced about a radially-inward facing surface of the valve seat.

14. The breathing mask of claim 11. wherein the rotary slide valve additionally includes an air outlet opening configured to receive a check valve therein, the check valve covering the air outlet opening.

15. The breathing mask of claim 14, wherein the air inlet openings of the rotary slide valve are evenly spaced around the air outlet opening.

16. The breathing mask of claim 14, wherein the check valve includes a membrane covering the air outlet opening, the membrane being configured to substantially prevent airflow through the air outlet opening during inhalation and to allow airflow through the air outlet opening during exhalation.

17. The breathing mask of claim 11, wherein the rotary slide valve is configured to engage the seat opening with one or more axial spring tongues.

18. The breathing mask of claim 11, further comprising a secondary air inlet opening configured to remain open to airflow at all rotational positions of the rotary slide valve.

19. The breathing mask of claim 11, wherein the air inlet openings of the valve seat are evenly spaced around the seat opening.

20. The breathing mask of claim 11, further comprising a mask body configured to cover a mouth and nose, the mask body including a flexible sealing edge configured to form an airtight connection with the face.
